(19) United States
(12) Patent Application Publication
(10) Pub. No.: US 2008/0064437 A1
(43) Pub. Date: Mar. 13, 2008

(54) Mobile Communication Device Having Stereoscopic Imagemaking Capability

(76) Inventors: Michael J. Chambers, Erlangen (DE); Michael Kiessling, Freising (DE)

Correspondence Address: HITT GAINES, PC;LSI Corporation, PO BOX 832570, RICHARDSON, TX, 75083, US

(21) Appl. No.: 11/576,145

(22) PCT Filed: Sep. 27, 2004
(86) PCT No.: PCT/US04/31676

§ 371 Date: Sep. 19, 2007

(51) Int. Cl. H04M 1/00

(52) U.S. Cl. 455/556.1

(57) ABSTRACT

A mobile communication device (e.g., a wireless telephone) capable of making stereoscopic images. In one embodiment, the mobile communication device includes: (1) a main body, (2) first and second camera modules rotatably attached to the main body and (3) a drive structure coupled to the first and second camera modules and configured to rotate the first and second camera modules relative to the main body about corresponding first and second axes of rotation.

### TECHNICAL FIELD OF THE INVENTION

The present invention is directed, in general, to mobile communication devices and, more specifically, to a mobile communication device having a stereoscopic imagemaking capability.

### BACKGROUND OF THE INVENTION

Today's photography and cinema are predominantly based on two-dimensional images. Fortunately, the human mind is reasonably capable, based on experience, of inferring three-dimensional relationships among the two-dimensional objects in a two-dimensional image. The result is that two-dimensional images convey more information to the viewer than they contain.

Nevertheless, attempts have been over the last centuries to reproduce the three-dimensional image the human brain forms by composing the two partial images from separate right and left eyes. A practical method known as “image separation” deceives the human brain by artificially producing the two views, one for the right eye and one for the left eye. If the quality of the artificial views is sufficient, the brain reconstructs a three-dimensional image.

The term “stereoscopic image” or “stereoscopic three-dimensional image” is also often used and shall be defined for purposes of the present invention as a set of at least two images depicting at least two slightly different views of the same object or scene. When the different views are supplied in a suitable way for viewing separately with the right and left eye of an observer a three-dimensional impression is achieved.

U.S. Patent Application Number 2001/0030682 A1 discloses a video camera that makes use of image separation to create stereoscopic images. Image separation is sometimes employed in digital photography, wherein two digital cameras are mounted on a tripod. Alternatively a single digital camera mounted on a tripod with a horizontal slidebar can be used for capturing two images with the camera brought sequentially into different positions by means of the slidebar. However, these solutions are complicated and require extensive equipment and patience.

At the same time, mobile communication devices (such as wireless telephones) are being equipped with digital cameras at affordable prices, allowing new multimedia services to be provided to users. It is possible by means of such services to take digital photographs and send them to a friend by means of the multimedia message system (MMS). It is also possible to record video clips and send them by means of an MMS.

What is needed in the art is a way to produce stereoscopic images with a mobile communication device. What is further needed in the art is a way to produce stereoscopic images that is convenient for the user and requires less equipment than is possible today.

### SUMMARY OF THE INVENTION

To address the above-discussed deficiencies of the prior art, the present invention provides a mobile communication device (e.g., a wireless telephone) capable of making stereoscopic images. In one embodiment, the mobile communication device includes: (1) a main body, (2) first and second camera modules rotatably attached to the main body and (3) a drive structure coupled to the first and second camera modules and configured to rotate the first and second camera modules relative to the main body about corresponding first and second axes of rotation. The present invention therefore introduces the broad concept of providing a mobile communication device with multiple cameras that are capable of converging on a point and capturing standard images that are combinable to create a stereoscopic image.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates an elevational view of one embodiment of a mobile communication device having stereoscopic imagemaking capability and constructed according to the principles of the present invention;

FIG. 2 illustrates a plan view of the mobile communication device of FIG. 1, showing in particular autofocus communication device of FIG. 1, showing in particular a camera module that is retractable into the main body of the mobile communication device.

### DETAILED DESCRIPTION

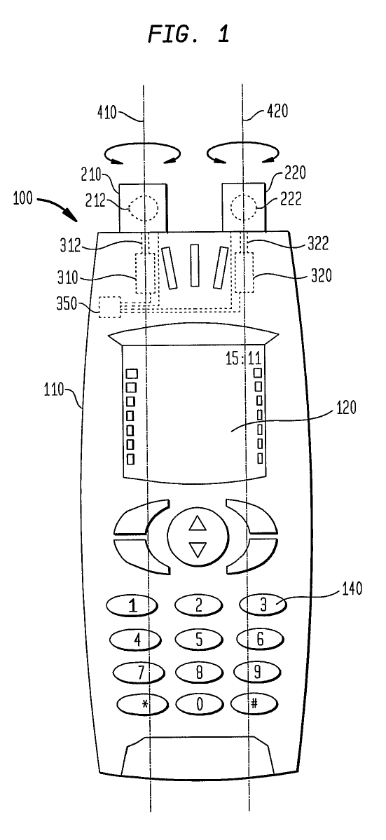

Referring initially to FIG. 1, illustrated is an elevational view of one embodiment of a mobile communication device having stereoscopic imagemaking capability and constructed according to the principles of the present invention. FIG. 1 shows a mobile communication device 100 having a main body and first and second camera modules 210, 220 attached to the main body 110. The first camera module 210 is rotatable around a first axis of rotation 410. In the illustrated embodiment, the automatic rotation is achieved by way of a first motor 310, which is connected to the camera module 210 by a first drive shaft 312. In a like manner, the second camera module 220 is rotatable around a second axis of rotation 420. In the illustrated embodiment, the rotation is being achieved by a second motor 320, which is connected to the second camera module 220 by a second drive shaft 322. In the illustrated embodiment, because the first and second motors 310, 320 drive the respective first and second camera modules 210, 220, the first and second camera modules 210, 220 may be said to be automatically rotatable about their respective axes of rotation 410, 420. Further, the first and second motors 310, 320 and the first and second drive shafts 312, 322 may be considered as a drive structure for driving the first and second camera modules 210, 220. Those skilled in the art will understand, however, that other drive structures, including manually operated drive structures, fall within the broad scope of the present invention.

The first and second camera modules 210, 220 are shown with respective first and second lenses 212, 222 facing a back side of the mobile communication device 100. The front side of the mobile communication device is defined as the side of the mobile communication device 100 on which a display 120 and a keypad 140 are arranged. This is the typical arrangement for capturing stereoscopic images with a preview of the image shown on the display 120. The preview does not have to be a stereoscopic image, but could alternatively be a two-dimensional image generated by one of the first and second camera modules 210, 220. But the display 120 can also be adapted for the display of stereoscopic images, for instance by mechanism of an integrated optical mask.

The mobile communication device 100 can accommodate a stereoscopic video conferencing mode wherein the first and second camera modules 210, 220 may be rotated to face to the front side of the mobile communication device 100. This allows the first and second camera modules 210, 220 to capture a stereoscopic image of the user, while at the same time allowing the user to see an image of his video conferencing partner on the display 120.

In the illustrated embodiment, the first and second camera modules 210, 220 are adapted for autofocus functionality. A synchronizing mechanism 350 is advantageously provided to synchronize the autofocus with the rotation performed by the first and second motors 310, 320.

In the illustrated embodiment, the first and second camera modules 210, 220 are mounted on the top of the main body 110. Of course, the first and second camera modules 210, 220 could also be mounted on the side of the main body 110 or at any other suitable position. For instance, the first and second camera modules 210, 220 could be integrated into the main body 110, since for capturing stereoscopic images only small angular displacements of the first and second camera modules 210, 220 are necessary.

Of course, the invention is not limited to mobile phones, but can also be used for personal digital assistants (PDA) or mobile digital assistants (MDA) or any other conventional or later-discovered mobile communication device.

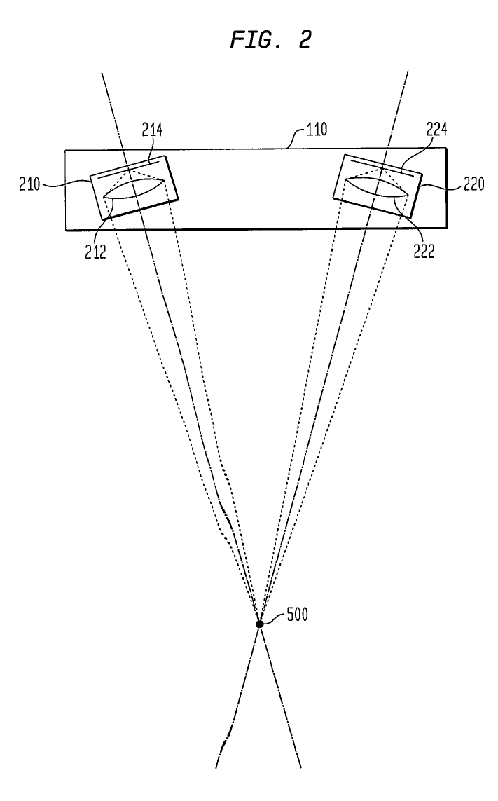

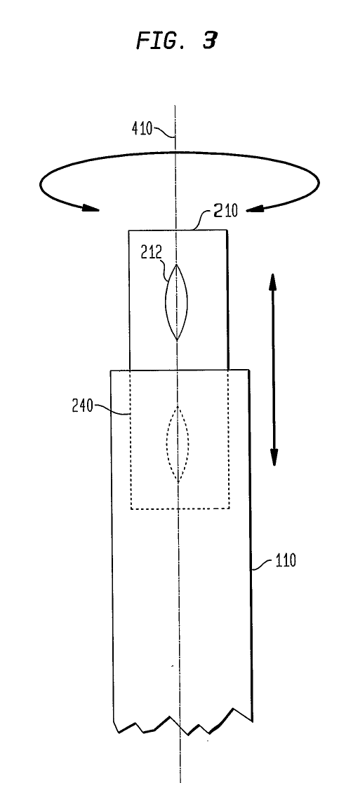

Turning now to FIG. 2, illustrated is a plan view of the mobile communication device of FIG. 1, showing in particular autofocus synchronizing and concomitant first (left) and second (right) camera module rotation. In a schematic top view, FIG. 2 shows the first and second camera modules 210, 220 rotated into certain positions relative to the main body 110. In these positions, the focal point of the lens system 212 of the first camera module 210 and the focal point of the lens system 222 of the second camera module 220 fall together at the location of an object of focus 500. A focused image of the same object from different points of view is thereby projected on the planes of the respective imaging sensors 214, 224.

In the illustrated embodiment, this process is controlled by the synchronizing mechanism 350, which synchronizes the autofocus of the first and second camera modules and the rotation of the first and second camera modules. This can comprise determining the distance of the object to be depicted from the device on the basis of the autofocus adjustments. From this distance, the relative angles of rotation of the first and second camera modules can be calculated by means of known triangulation methods. For this purpose, the synchronizing mechanism 350 may include a memory with a stored software program and a microprocessor by which the software program can be executed.

In the illustrated embodiment, the synchronizing mechanism 350 is further adapted to cause the first and second camera modules to simultaneously capture an image. The resulting stereoscopic image comprises a set of two images, one captured from each of the first and second camera modules 210, 220, and can be stored in a memory of the mobile communication device 100. The stereoscopic image can then for instance be displayed on the display 120 or sent via email or MMS (Multimedia Messaging Service) to another mobile phone.

Turning now to FIG. 3, illustrated is a side view of the mobile communication device of FIG. 1, showing in particular a camera module that is retractable into the main body of the mobile communication device. In the embodiment of FIG. 3, the first camera module 210 is retractable from an exposed position into the main body 110 of the mobile communication device 100. The first camera module 210 is located in the retracted position when not in use. In the retracted position 240, the first camera module 210 is protected against external influences.

For user convenience the mobile communication device 100 may include a spring mechanism (not shown), by which the first camera module 210 can be automatically ejected and brought into the exposed position. A retaining mechanism (not shown) may also be provided to hold back the spring mechanism until released by the user.

Although not shown in FIG. 3, the second camera module 220 is also retractable from an exposed position into the main body of the mobile communication device 100 in the same way as described above for the first camera module 210.

For practical purposes, the first and second camera modules 210, 220 may further include a flash, a self-timer or both. The self-timer may be connected to an indicator to indicate to the user the elapsing of the delay time of the self-timer. These features also are not shown in the FIGUREs.

Although the present invention has been described in detail, those skilled in the art should understand that they can make various changes, substitutions and alterations herein without departing from the spirit and scope of the invention in its broadest form.

What is claimed is:

1. A mobile communication device, comprising:
a main body;
first and second camera modules rotatably attached to said main body; and
a drive structure coupled to said first and second camera modules and configured to rotate said first and second camera modules relative to said main body about corresponding first and second axes of rotation.

2. The mobile communication device as recited in claim 1 wherein said first and second axes of rotation are essentially parallel.

3. The mobile communication device as recited in claim 1 wherein each of said first and second camera modules are provided with an optical lens, an optical center of said lens being located on a respective one of said at least one first and second axis of rotation.

4. The mobile communication device as recited in claim 1 wherein said drive structure is configured to synchronize rotation of said first and second camera modules.

5. The mobile communication device as recited in claim 1 further comprising an autofocus mechanism configured to focus a lens of a selected one of said first and second camera modules on an object.

6. The mobile communication device as recited in claim 5 wherein said autofocus mechanism is configured to focus lenses of both said first and second camera modules on said object.

7. The mobile communication device as recited in claim 5 wherein said autofocus mechanism controls said drive structure.

8. The mobile communication device as recited in claim 7 wherein said autofocus mechanism causes said drive structure to rotate said first and second camera modules to converge on a single point and further causes said lenses of said first and second camera modules to focus on said single point.

9. The mobile communication device as recited in claim 8 wherein said first and second camera modules are configured to simultaneously capture an image.

10. The mobile communication device as recited in claim 1 further comprising a display configured to display a stereoscopic image.

11. The mobile communication device as recited in claim 1 further comprising a memory containing a stored software program configured to control a synchronization mechanism.

12. The mobile communication device as recited in claim 1 wherein said first and second camera modules are configured to translate with respect to said main body between a retracted and an exposed position.

13. The mobile communication device as recited in claim 12 further comprising a user-releasable retainer structure configured to hold said first and the second camera modules in respective retracted positions.

14. The mobile communication device as recited in claim 1 wherein said first and second camera modules are integral with said main body.
